(19) United States
(12) Patent Application Publication
(10) Pub. No.: US 2012/0128397 A1
(43) Pub. Date: May 24, 2012

(54) SHEET DE-CURLING MECHANISM AND PRINTING APPARATUS USING THE SAME

(76) Inventor: Yu-Lun CHANG, Miao-Li County (TW)

(21) Appl. No.: 13/300,284

(22) Filed: Nov. 18, 2011

(30) Foreign Application Priority Data
Nov. 24, 2010 (TW) 099140483

(51) Int. Cl. G03G 15/00; B65H 5/36; B65H 5/06

(52) U.S. Cl. 399/406; 271/272; 271/226

(57) ABSTRACT

A sheet de-curling mechanism includes a passageway, a first roller and a second roller. The first roller, disposed in the passageway, transports a sheet at a first speed in a transporting direction. The second roller, disposed downstream of the first roller, transports the sheet at a second speed greater than the first speed, to stretch and flatten the sheet. A printing apparatus using the sheet de-curling mechanism is also provided.

This application claims priority of No. 099140483 filed in Taiwan R.O.C. on Nov. 24, 2010 under 35 USC 119, the entire content of which is hereby incorporated by reference.

### BACKGROUND OF THE INVENTION

1. Field of the Invention

The present invention relates to a sheet de-curling mechanism and a printing apparatus using the same, and more particularly to a sheet de-curling mechanism using a speed difference between rollers to stretch and flatten a sheet, and a printing apparatus using the same.

2. Related Art

Generally, an electronphotography process of a laser printer involves the steps of charging, exposing, developing, transferring, fusing and cleaning in order to generate print images of texts and graphs.

After the laser printer transfers the toner particles to a paper sheet, in the fusing step the printer heats and fixes the toner particles on the sheet to complete the printing process. However, because during the fusing operation the paper sheet undergoes heat and pressure, the paper sheet thus takes the shape of the pressure roller in the fusing station and a curl or bend is frequently induced. This curling of the paper sheet affects the stacking of the printed sheets or even causes paper jam in the passageway, thereby bringing a lot of inconvenience.

### SUMMARY OF THE INVENTION

Accordingly, the present invention has been proposed to solve the problems of the prior art, and it is an object of the present invention to provide a sheet de-curling mechanism and a printing apparatus using the same, in which a sheet is stretched and flattened due to a speed difference between the rollers, to solve the aforementioned stacking and paper jam problems.

To achieve the above-identified object, the present invention provides a sheet de-curling mechanism including a passageway, a first roller and a second roller. The first roller, disposed in the passageway, transports a sheet at a first speed in a transporting direction. The second roller, disposed downstream of the first roller, transports the sheet at a second speed greater than the first speed, to stretch and flatten the sheet.

The present invention also provides a printing apparatus including the sheet de-curling mechanism and a fusing device. The fusing device, disposed upstream of the sheet de-curling mechanism, fuses toner particles on a sheet.

According to the present invention, it is possible to reduce the curling of the printed sheets, prevent the paper jam from occurring in the passageway, and stack paper sheets properly in the discharge tray.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1 is a pictorial view of a printing apparatus according to the present invention.

FIG. 2 is a schematic illustration of a printing apparatus according to a first embodiment of the present invention.

FIG. 3 is a schematic illustration of a printing apparatus according to a second embodiment of the present invention.

FIG. 4 is a schematic illustration of a printing apparatus according to a third embodiment of the present invention.

### DETAILED DESCRIPTION OF THE INVENTION

The present invention will be apparent from the following detailed description, which proceeds with reference to the accompanying drawings.

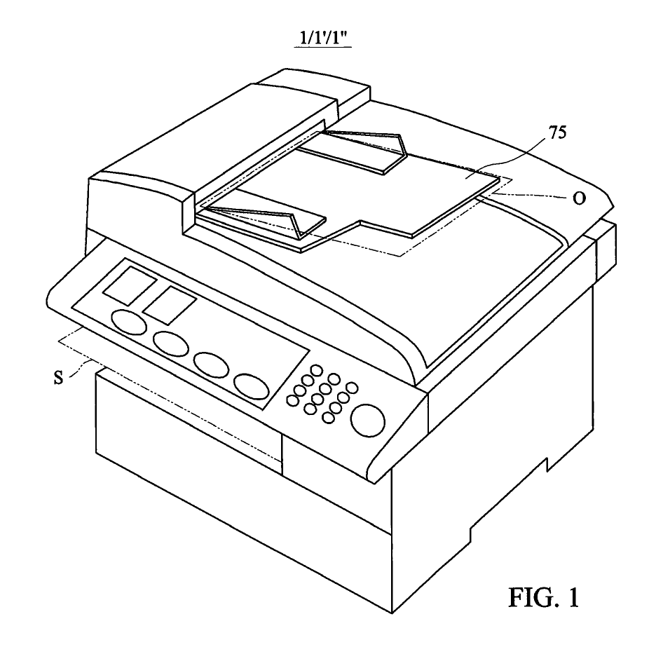

FIG. 1 is a pictorial view of a printing apparatus 1/1′/1″ according to the present invention. As shown in FIG. 1, the printing apparatus 1/1′/1″ of the present invention is a multi-function printer which is at least capable of scanning an original O from an original supply tray 75 and printing an image of the original O on a sheet S. However, the present invention is not particularly restricted thereto, and the printing apparatus 1/1′/1″ may be a single function printer. In the present invention, a laser printer engine is used in the print apparatus 1/1′/1″ as an example. Alternatively, a thermal transfer print may also be used.

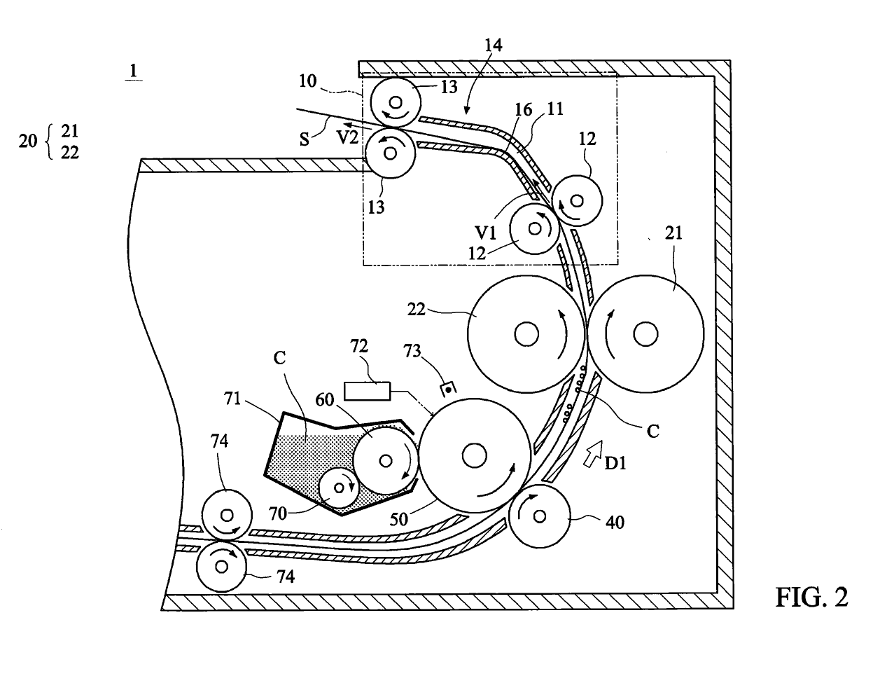

FIG. 2 is a schematic illustration of the printing apparatus 1 according to a first embodiment of the present invention. Referring to FIG. 2, the printing apparatus 1 of this embodiment includes a sheet de-curling mechanism 10 and a fusing device 20. The sheet de-curling mechanism 10 includes a passageway 11, a first roller 12 and a second roller 13. Although two first rollers 12 and two second rollers 13 are shown in the drawing, the present invention may also be implemented using only a first roller 12 and a second roller 13 working in conjunction with the other structures of the printing apparatus 1.

The fusing device 20, disposed upstream of the sheet de-curling mechanism 10, fuses the toner particles C, on the sheet S. The upstream and downstream are defined by the traveling path of the sheet S. The sheet S travels past the fusing device 20 and then the sheet de-curling mechanism 10.

In this embodiment, the fusing device 20 includes a pressure roller 21 and a heating roller 22. The pressure roller 21 is rotatably disposed upstream of the sheet de-curling mechanism 10. The heating roller 22, rotatably disposed, heats the sheet S. The pressure roller 21 and the heating roller 22 clamp the sheet S therebetween, while fusing the toner particles on the sheet S, and transport the sheet S into the passageway 11. It is to be noted that the fusing device 20 may have other configurations and is not particularly restricted to that illustrated in the present invention. For example, the fusing device may include an infrared box, or a xenon lamp used in some high-speed, expensive printers.

The first roller 12, disposed in the passageway 11, transports the sheet S in a transporting direction D1 at a first speed V1. The second roller 13, disposed downstream of the first roller 12, transports the sheet S at a second speed V2 greater than the first speed V1. The speed difference between the second speed V2 and the first speed V1 stretches and flattens the sheet S. In order to prevent the sheet from slipping or being torn, the second speed V2 is preferably greater than the first speed V1 and up to about 110% of the first speed V1.

The sheet de-curling mechanism 10 further includes a sheet guiding member 14 disposed between the first roller 12 and the second roller 13. The sheet guiding member 14 has a convex portion 16 configured to press against the sheet S as the sheet S passes by the sheet guiding member 14 to assist in stretching and flattening the sheet S. As shown in FIG. 2, the sheet guiding member 14 is a movable guide plate and the convex portion 16 is a curved face of the guide plate projecting towards the passageway 11. The curved face has an arced or curved shape which makes paper sheets pass smoothly. The difference between the second speed V2 and the first speed V1 and the pressing force of the convex portion 16 stretch and flatten the sheet S. The convex portion 16 may be a rigid structure or an elastically deformable structure which is deformable and flexible under the pressure applied by the sheet S.

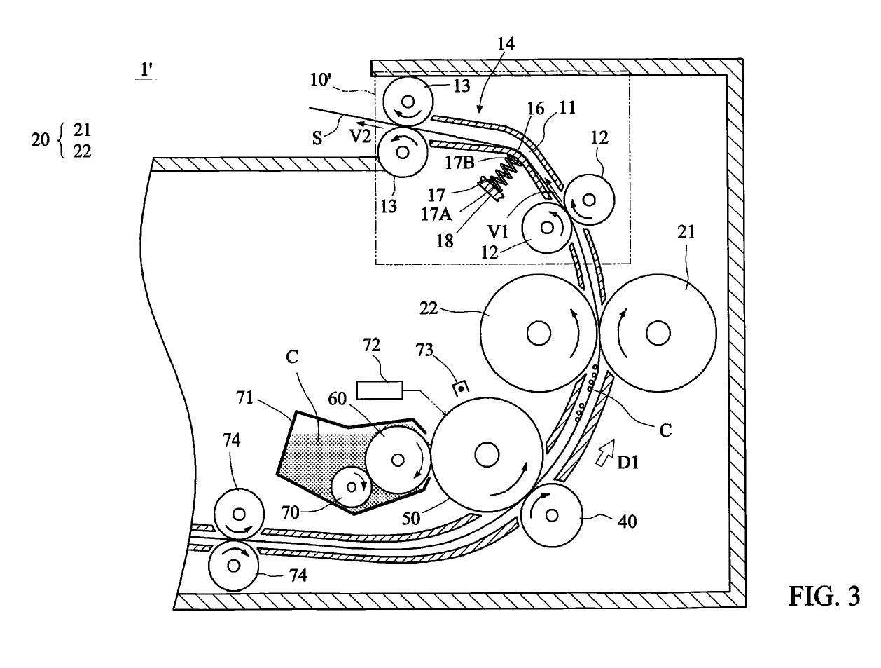

FIG. 3 is a schematic illustration of a printing apparatus 1′ according to a second embodiment of the present invention. As shown in FIG. 3, the structure of printing apparatus 1′ of this embodiment is similar to the printing apparatus 1 of the first embodiment except that the sheet de-curling mechanism 10′ further includes an elastic member 17 providing a resilient force to the sheet guiding member 14. The elastic member 17 has an end 17B abutting against the sheet guiding member 14 and the other end 17A attached to a body 18. In this embodiment, the end 17B of the elastic member 17 supports the convex portion 16. However, the present invention is not limited thereto, and the end 17B of the elastic member 17 may be attached to any portion of the sheet guiding member 14 as long as the convex portion 16 can be moved by the pressure applied by the sheet S. In this case, the sheet guiding member 14 provides a buffering space for the sheet S and prevents tearing of the sheet S. By the resilient force of the elastic member 17, the sheet guiding member 14 presses against the sheet S to assist in stretching the sheet S. Alternatively, the sheet guiding member 14 may also be pre-loaded to exert a force on the sheet S.

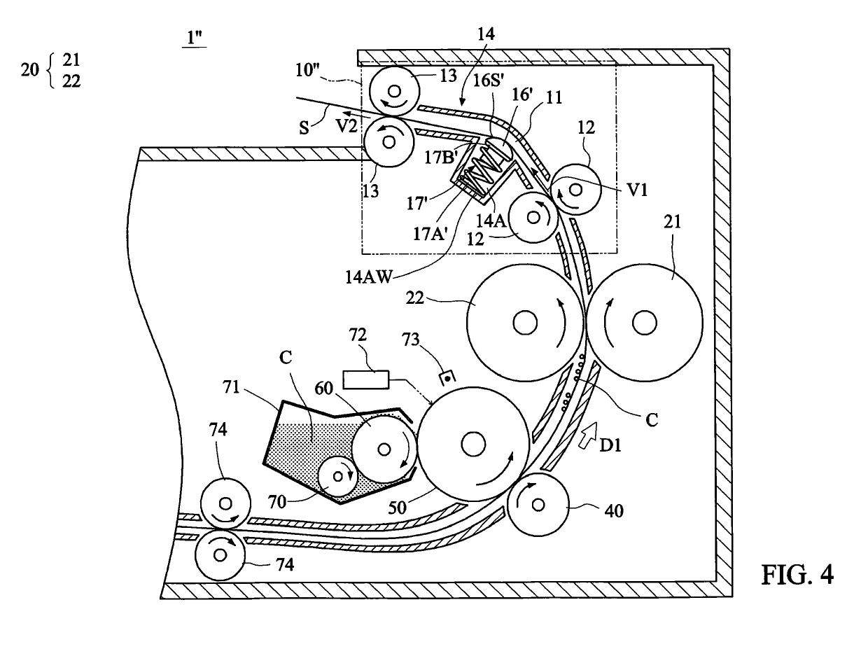

FIG. 4 is a schematic illustration of a printing apparatus 1″ according to a third embodiment of the present invention. As shown in FIG. 4, the printing apparatus 1″ of this embodiment is similar to the printing apparatus 1′ of the second embodiment except that the sheet guiding member 14 is movable and seated in a recess 14A. A convex portion 16′ of the sheet guiding member 14 protrudes from the recess 14A to press against the paper sheet S passing by the sheet guiding member 14. In this embodiment, the sheet de-curling mechanism 10″ also includes an elastic member 17′ providing a resilient force to the sheet guiding member 14. The elastic member 17′ has a first end 17A′ attached to a wall 14AW of the recess 14A and a second end 17B′ abutting against the sheet guiding member 14. In this embodiment, the sheet guiding member 14 is a movable knob, and the knob has a convex surface 16S′ for pressing against the sheet S.

In addition, the printing apparatus 1/1′/1″ of FIGS. 2, 3 and 4 further includes a charger 73, a laser scanning unit 72, a transfer roller 40, a drum 50, a development roller 60 and a supply roller 70. The charger 73 charges the rotatable drum 50. The laser scanning unit 72 emits laser beams to form a latent image on the drum 50. Toner particles C are accommodated within a toner cartridge 71. The supply roller 70, rotatably disposed in the toner cartridge 71, supplies the toner particles C to the rotating development roller 60. The toner particles C are developed onto the latent image on the drum 50 by the development roller 60 to form a toner image. The transfer roller 40 and the drum 50, rotatably disposed upstream of the heating roller 22, nip the sheet S transported by the rollers 74, and transfer the toner image onto the sheet S. Next, the sheet S is subjected to the fusing processing of the fusing device 20. The fused sheet S is then subjected to the de-curling process of the sheet de-curling mechanism 10/10′/10″ of the present invention, and finally the printed and de-curled sheet S is outputted.

According to the present invention, it is possible to prevent the printed sheets from curling, prevent the paper jam from occurring in the passageway, and make the printed sheets be stored in the discharge tray in a leveled manner.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A sheet de-curling mechanism, comprising:
a passageway;
a first roller, disposed in the passageway, for transporting a sheet at a first speed in a transporting direction; and
a second roller, disposed downstream of the first roller, for transporting the sheet at a second speed greater than the first speed, to stretch and flatten the sheet.

2. The mechanism according to claim 1, further comprising:
a sheet guiding member disposed between the first roller and the second roller, the sheet guiding member having a convex portion configured to press against the sheet as the sheet passes by the sheet guiding member to assist in stretching and flattening the sheet.

3. The mechanism according to claim 2, wherein the sheet guiding member is a guide plate and the convex portion is a curved face of the guide plate projecting towards the passageway.

4. The mechanism according to claim 3, wherein the convex portion is deformable and flexible under the pressure applied by the sheet.

5. The mechanism according to claim 3, wherein the guide plate is movable, and the mechanism further comprises:
an elastic member, abutting against the sheet guiding member, for providing a resilient force to the sheet guiding member.

6. The mechanism according to claim 2, wherein the sheet guiding member is seated in a recess and protrudes from the recess.

7. The mechanism according to claim 6, wherein the sheet guiding member is movable in the recess, and the mechanism further comprises:
an elastic member, having a first end attached to a wall of the recess and a second end abutting against the sheet guiding member, for providing a resilient force to the sheet guiding member.

8. The mechanism according to claim 7, wherein the sheet guiding member is a movable knob having a convex surface for pressing against the sheet.

9. The mechanism according to claim 1, wherein the second speed is greater than the first speed and up to about 110% of the first speed.

10. A printing apparatus, comprising:
a sheet de-curling mechanism, comprising:
a passageway;
a first roller, disposed in the passageway, for transporting a sheet at a first speed in a transporting direction; and
a second roller, disposed downstream of the first roller, for transporting the sheet at a second speed greater than the first speed, to stretch and flatten the sheet; and
a fusing device, disposed upstream of the sheet de-curling mechanism, for fusing toner particles on the sheet.

11. The apparatus according to claim 10, wherein the sheet de-curling mechanism further comprises:
a sheet guiding member disposed between the first roller and the second roller, the sheet guiding member having a convex portion configured to press against the sheet as the sheet passes by the sheet guiding member to assist in stretching and flattening the sheet.

12. The apparatus according to claim 11, wherein the sheet guiding member is a guide plate and the convex portion is a curved face of the guide plate projecting towards the passageway.

13. The apparatus according to claim 12, wherein the convex portion is deformable and flexible under the pressure applied by the sheet.

14. The apparatus according to claim 12, wherein the guide plate is movable, and the sheet de-curling mechanism further comprises:
an elastic member, abutting against the sheet guiding member, for providing a resilient force to the sheet guiding member.

15. The apparatus according to claim 11, wherein the sheet guiding member is seated in a recess and protrudes from the recess.

16. The apparatus according to claim 15, wherein the sheet guiding member is movable in the recess, and the sheet de-curling mechanism further comprises:
an elastic member, having a first end attached to a wall of the recess and a second end abutting against the sheet guiding member, for providing a resilient force to the sheet guiding member.

17. The apparatus according to claim 16, wherein the sheet guiding member is a movable knob having a convex surface for pressing against the sheet.

18. The apparatus according to claim 10, wherein the second speed is greater than the first speed and up to about 110% of the first speed.
